(19) United States
(12) Patent Application Publication
(10) Pub. No.: US 2013/0020493 A1
(43) Pub. Date: Jan. 24, 2013

(54) RADIATION IMAGING APPARATUS AND RADIATION IMAGING SYSTEM

(71) Applicants: Takamasa Ishii, Honjo-shi (JP); Yoshito Sasaki, Honjo-shi (JP)

(72) Inventors: Takamasa Ishii, Honjo-shi (JP); Yoshito Sasaki, Honjo-shi (JP)

(73) Assignee: CANON KABUSHIKI KAISHA, Tokyo (JP)

(21) Appl. No.: 13/523,098

(22) Filed: Jun. 14, 2012

(30) Foreign Application Priority Data
Jul. 19, 2011 (JP) 2011-158453

(51) Int. Cl. G01T 1/16

(52) U.S. Cl. 250/394

(57) ABSTRACT

A radiation imaging apparatus comprising: a detection apparatus having detection regions; at least one plate having transmitting regions arranged in an array for adjusting the amount of radiation incident on the detection regions by blocking radiation incident on a region other than the transmitting regions; a holding unit that holds the plate in such a manner that the plate can move along the detection surface while being kept in a position over the detection surface of the detection apparatus; and a drive unit that moves the plate, is provided. The drive unit can fix the plate in various positions relative to the detection surface, and the area of a part of the detection region on which radiation transmitted through the plate is incident varies depending on the position of the plate.

### BACKGROUND OF THE INVENTION

1. Field of the Invention

The present invention relates to a radiation imaging apparatus and a radiation imaging system.

2. Description of the Related Art

Generally, methods of image shooting that use a radiation imaging apparatus are classified into still image shooting and moving image shooting. In the field of medical diagnostic imaging in particular, a shooting method appropriate for each diagnostic purpose is selected, and the amount of radiation used also varies. Diagnosis that uses a still image requires an image of an object that is clear in every detail. Generally, radiation emitted toward a subject contains a noise component, and the larger the amount of radiation, the smaller is the ratio of the noise component. For this reason, in still image shooting, a favorable image can be acquired by increasing the amount of radiation. On the other hand, diagnosis that uses a moving image requires an image in which movement of the object is smooth. Since a moving image is composed of a plurality of still images (frames), it is desirable that more still images are acquired per unit time, while it is desired to decrease the amount of radiation which a patient who is the subject is exposed to. Therefore, it is desirable that a radiation imaging apparatus for moving image shooting can achieve a high S/N so that a favorable moving image can be obtained even at a small amount of radiation.

Japanese Patent Laid-Open No. 9-98970 discloses an X-ray imaging apparatus that eliminates scattered X-rays by fixing a grid formed from a substance that absorbs X-rays and a substance that transmits X-rays onto a detection apparatus in order to achieve a high S/N. Japanese Patent Laid-Open No. 2005-152002 proposes a fluoroscopic radiography apparatus that can retract a scattered X-ray eliminating grid disposed on an FPD to a retracted position outside the FPD. For example, in cases of acquiring a correction coefficient or in cases where the subject is an infant, the X-ray exposure dose is lowered by adjusting the amount of radiation incident on the FPD using this fluoroscopic radiography apparatus.

### SUMMARY OF THE INVENTION

The fluoroscopic radiography apparatus disclosed in Japanese Patent Laid-Open No. 2005-152002 moves the grid to the position outside the FPD using a mechanical mechanism. For this reason, it was difficult to reduce the size of the fluoroscopic radiography apparatus. To address this issue, an aspect of the present invention provides a technology that realizes a small radiation imaging apparatus capable of adjusting the sensitivity.

A first aspect of the present invention provides a radiation imaging apparatus comprising: a detection apparatus that has a detection surface on which a plurality of detection regions detecting radiation are arranged in an array and generates a signal corresponding to the amount of radiation incident on each of the detection regions; at least one adjusting plate in which a plurality of transmitting regions transmitting radiation are arranged in an array and which adjusts the amount of radiation incident on the plurality of detection regions by blocking radiation incident on a region other than the plurality of transmitting regions; a holding unit that holds the at least one adjusting plate in such a manner that the at least one adjusting plate can move along the detection surface while being kept in a position over the detection surface of the detection apparatus; and a drive unit that moves the at least one adjusting plate, wherein the drive unit can fix the at least one adjusting plate in a plurality of positions relative to the detection surface, and in at least one of the plurality of detection regions, the area of a part of the detection region on which radiation transmitted through the at least one adjusting plate is incident varies depending on the position of the at least one adjusting plate relative to the detection surface.

A second aspect of the present invention provides a radiation imaging apparatus comprising: a detection apparatus that has a detection surface on which a plurality of detection regions detecting radiation are arranged in an array and generates a signal corresponding to the amount of radiation incident on each of the detection regions; an adjusting plate in which a plurality of transmitting regions transmitting radiation are arranged in an array and which adjusts the amount of radiation incident on the plurality of detection regions by blocking radiation incident on a region other than the plurality of transmitting regions; a holding unit that removably holds the adjusting plate and guides the adjusting plate to a position over the detection surface of the detection apparatus; and a fixing unit that fixes the adjusting plate guided to the position, wherein in at least one of the plurality of detection regions, the area of a part of the detection region on which radiation is incident when the adjusting plate is removed is larger than the area of a part of the detection region on which radiation transmitted through the adjusting plate is incident when the adjusting plate is fixed in the position.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention, and together with the description serve to explain the principles of the invention.

FIGS. 1A to 1C are diagrams illustrating an example of the configuration of a radiation imaging apparatus according to an embodiment of the present invention.

FIG. 2 is a diagram illustrating a part of the radiation imaging apparatus according to the embodiment of the present invention.

FIGS. 3A and 3B are diagrams illustrating the position of an adjusting plate according to the embodiment of the present invention.

FIGS. 4A and 4B are diagrams illustrating the position of the adjusting plate according to the embodiment of the present invention.

FIG. 5 is a diagram illustrating an influence of the position of the adjusting plate according to the embodiment of the present invention.

FIGS. 6A to 6C are diagrams illustrating an example of the configuration of a radiation imaging apparatus according to another embodiment of the present invention.

FIG. 7 is a diagram illustrating a part of the radiation imaging apparatus according to the other embodiment of the present invention.

FIGS. 8A and 8B are diagrams illustrating the positions of adjusting plates according to the other embodiment of the present invention.

FIGS. 9A and 9B are diagrams illustrating the positions of the adjusting plates according to the other embodiment of the present invention.

FIGS. 10A and 10B are diagrams illustrating an example of the configuration of a radiation imaging apparatus according to a further embodiment of the present invention.

FIGS. 11A and 11B are diagrams illustrating attachment/removal of an adjusting plate according to the further embodiment of the present invention.

FIG. 12 is a diagram illustrating a case where the adjusting plate according to the further embodiment of the present invention is displaced.

FIG. 13 is a diagram illustrating an example of the configuration of a radiation imaging system according to an embodiment of the present invention.

### DESCRIPTION OF THE EMBODIMENTS

Hereinafter, embodiments of a radiation imaging apparatus and a radiation imaging system according to the present invention will be described based on the accompanying drawings. In the embodiments below, light includes visible light and infrared rays, and radiation includes X-rays, alpha rays, beta rays, and gamma rays.

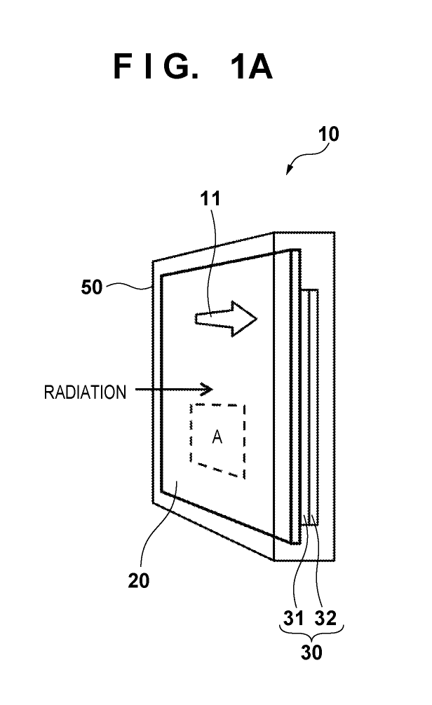

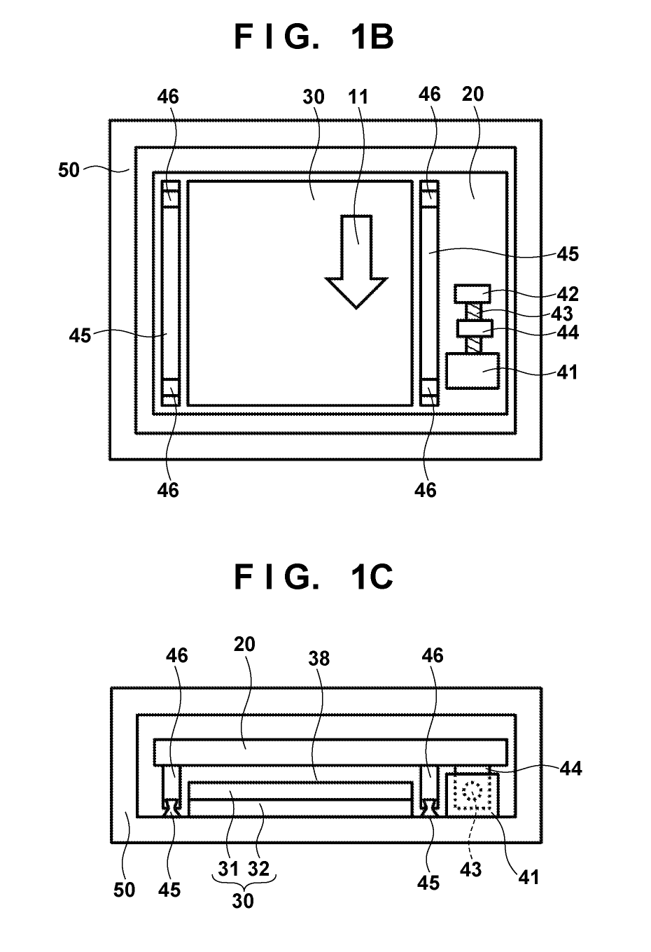

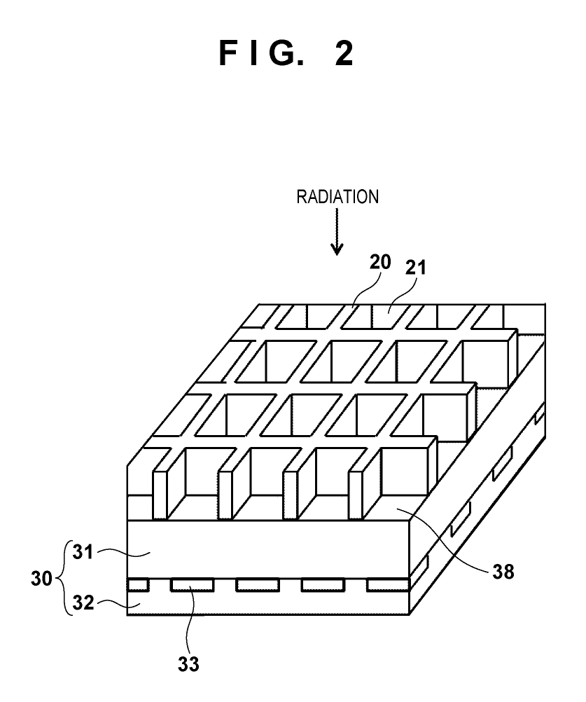

FIG. 1A is a concise overall view of a radiation imaging apparatus 10 according to an embodiment of the present invention, and FIG. 2 is a perspective view focusing on a region A of the radiation imaging apparatus 10. FIG. 1A is a perspective view of the radiation imaging apparatus 10, FIG. 1B is a view of the radiation imaging apparatus 10 as seen from a direction of incidence of radiation, and FIG. 1C is a side view of the radiation imaging apparatus 10. For the sake of clarity, some of components are omitted from FIG. 1A.

The radiation imaging apparatus 10 may include a housing 50 as well as an adjusting plate 20 and a detection apparatus 30 housed in the housing 50. For the purpose of illustration, the housing 50 is shown as partially transparent in FIGS. 1A to 1C, and the housing 50 is omitted from FIG. 2. The adjusting plate 20 is disposed on a radiation incident side (left side in FIG. 1A) of the detection apparatus 30 and adjusts the amount of radiation incident on detection regions 34 (described later) of the detection apparatus 30. The adjusting plate 20 may be formed of a radiation absorbing member made of, for example, a heavy metal material such as lead. A plurality of apertures 21 arranged in an array are provided in the adjusting plate 20, and radiation passing through the apertures 21 can be incident on the detection apparatus 30. Meanwhile, radiation blocked by the adjusting plate 20 is not incident on the detection apparatus 30.

The detection apparatus 30 is fixed to the housing 50 and has a detection surface 38 on the radiation incident side. The detection apparatus 30 may generate signals corresponding to the amount of radiation incident on the plurality of detection regions 34 disposed on the detection surface 38. The detection apparatus 30 may have any configuration as long as signals corresponding to the amount of incident radiation can be detected, and may be configured using an existing technology. Hereinafter, an example of the configuration of the detection apparatus 30 will be briefly described. The detection apparatus 30 may include a scintillator 31 and a detection substrate 32. The scintillator 31 may be formed from a material such as a columnar crystal such as CsI:Tl or a particulate crystal such as GOS, and is disposed on the radiation incident side within the detection apparatus 30 and converts radiation incident on the detection apparatus 30 into visible light. The detection substrate 32 may have a plurality of image sensors 33 arranged in an array. The image sensors 33 may be CMOS sensors that use crystalline silicon, PIN sensors or MIS sensors that use amorphous silicon, or the like. The scintillator 31 may be formed directly on the detection substrate 32, or may be attached to the detection substrate 32 via a connecting member such as an adhesive material. In the example of the radiation imaging apparatus 10, the detection apparatus 30 includes the scintillator 31, but a detection apparatus that employs a direct method of converting radiation into electric charges without using a scintillator may also be used.

Radiation emitted from a radiation source (not shown) toward a subject (not shown) located between the radiation source and the radiation imaging apparatus 10 is transmitted through the subject while being attenuated by the subject, and is incident on the adjusting plate 20. Radiation passing through the adjusting plate 20 and reaching the detection surface 38 is converted into visible light by the scintillator 31, and the visible light is in turn incident on the detection substrate 32 and is converted into electric charges. The electric charges are read out to the outside by a peripheral circuit unit, which is not shown, as signals, which constitute image data. In cases where a moving image is captured, the above operation is repeated.

The radiation imaging apparatus 10 may further include rails 45 and supporting members 46. The rails 45 are fixed to the housing 50, and the supporting members 46 are fixed to the adjusting plate 20. The supporting members 46 are slidably engaged with the rails 45 at one end, and thus the adjusting plate 20 can move in the direction of, and in the reverse direction of an arrow 11 relative to the detection apparatus 30 while being kept in a position over the detection surface 38 of the detection apparatus 30. That is to say, the rails 45 and the supporting members 46 can function as a holding unit that holds the adjusting plate 20 in such a manner that the adjusting plate 20 can move along the detection surface 38 of the detection apparatus 30 while being kept in the position over the detection surface 38. As will be described in detail later, a position to which the adjusting plate 20 can move may include a high-sensitivity position and a low-sensitivity position with respect to the detection apparatus 30. The sensitivity of the detection apparatus 30 when the adjusting plate 20 is in the high-sensitivity position is higher than that when the adjusting plate 20 is in the low-sensitivity position.

The radiation imaging apparatus 10 may further include a drive unit including a motor 41, a screw box 42, a precision ball screw 43, and a nut 44. The motor 41 rotates the precision ball screw 43 clockwise and counterclockwise. The screw box 42 rotatably holds an end of the precision ball screw 43 on the opposite side from the motor 41. The nut 44 is attached to the precision ball screw 43 and is also fixed to the adjusting plate 20. This drive unit enables the adjusting plate 20 to move relative to the detection apparatus 30. For example, if the motor 41 rotates the precision ball screw 43 counterclockwise, the nut 44 approaches the motor 41, and the adjusting plate 20 moves in the direction indicated by the arrow 11 accordingly. On the other hand, if the motor 41 rotates the precision ball screw 43 clockwise, the nut 44 moves away from the motor 41, and the adjusting plate 20 moves in the reverse direction to the direction indicated by the arrow 11 accordingly.

The radiation imaging apparatus 10 may further include a control unit (not shown) that controls the operation of the drive unit. The number of rotations of the motor 41 that is required to move the adjusting plate 20 from the high-sensitivity position to the low-sensitivity position may be set in the control unit. Upon receipt of an instruction from a user to move the adjusting plate 20 from the high-sensitivity position to the low-sensitivity position, the control unit rotates the motor 41 the set number of rotations to move the adjusting plate 20 to the low-sensitivity position. Then, the control unit stops rotating the motor 41, thereby fixing the adjusting plate 20 in the low-sensitivity position. On the other hand, upon receipt of an instruction from the user to move the adjusting plate 20 from the low-sensitivity position to the high-sensitivity position, the control unit rotates the motor 41 the set number of rotations in the reverse direction to move the adjusting plate 20 to the high-sensitivity position and fixes it in that position. In this manner, the drive unit can fix the adjusting plate 20 in the high-sensitivity position and in the low-sensitivity position.

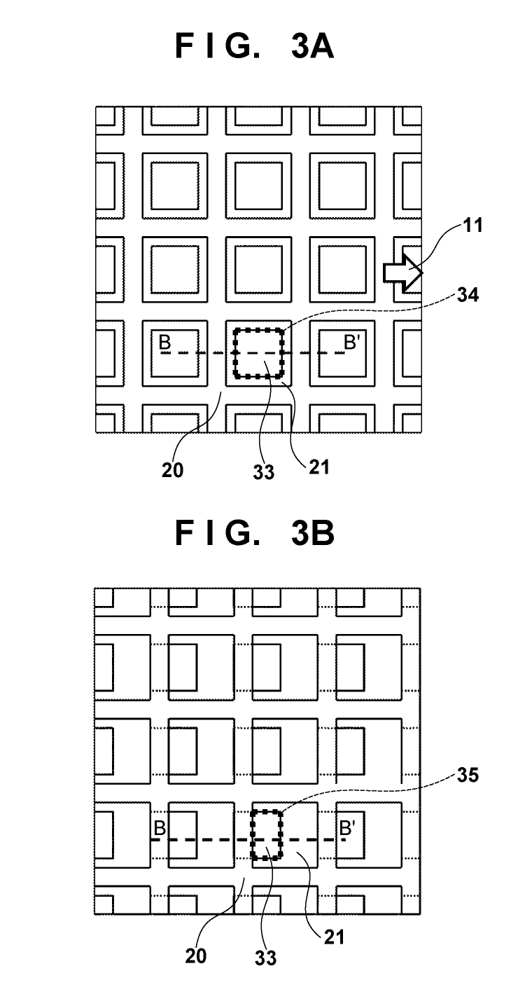

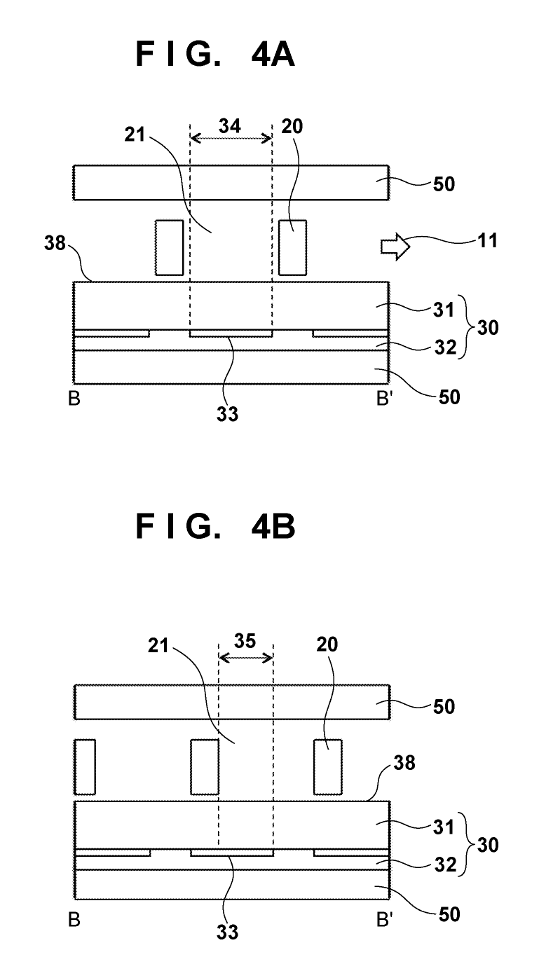

The high-sensitivity position and the low-sensitivity position of the adjusting plate 20 will be described in detail using FIGS. 3A, 3B, 4A, and 4B. FIGS. 3A and 3B are plan views of a region A in FIG. 1A as seen from the direction of incidence of radiation, and FIGS. 4A and 4B are cross-sectional views taken along line B-B′ in FIGS. 3A and 3B, respectively. In FIGS. 3A and 3B, the housing 50 is omitted and the adjusting plate 20 is shown as transparent for the purpose of illustration. FIGS. 3A and 4A show a state in which the adjusting plate 20 is in the high-sensitivity position, and FIGS. 3B and 4B show a state in which the adjusting plate 20 is in the low-sensitivity position. The detection surface 38 of the detection apparatus 30 has the plurality of detection regions 34 arranged in an array. Radiation incident on the detection regions 34 is converted by the scintillator 31 into visible light, which in turn reaches the image sensors 33. In these diagrams, the apertures 21 of the adjusting plate 20 correspond one-to-one to the detection regions 34, but it is also possible that a plurality of apertures 21 correspond to a single detection region 34. Also, in these diagrams, the area of each aperture 21 is larger than the area of each detection region 34, but the area of each aperture 21 may be equal to the area of each detection region 34 or may be smaller than the area of each detection region 34. If the plurality of detection regions 34 are arranged equidistantly, the plurality of apertures 21 may be arranged equidistantly as well. Moreover, in these diagrams, the apertures 21 have a square shape, but the apertures 21 may have any shape such as a rectangular shape, a trapezoidal shape, and a circular shape.

As shown in FIGS. 3A and 4A, when the adjusting plate 20 is in the high-sensitivity position, the apertures 21 overlie the entire detection regions 34. That is to say, the entire surface of the detection regions 34 can detect radiation incident on the radiation imaging apparatus 10. On the other hand, as shown in FIGS. 3B and 4B, when the adjusting plate 20 has moved from the high-sensitivity position in the direction of the arrow 11 to the low-sensitivity position, the apertures 21 overlie only regions 35 that are a part of the respective detection regions 34. That is to say, radiation incident on the radiation imaging apparatus 10 is incident only on the regions 35 and not on a part of the detection regions 34 covered by the adjusting plate 20 (the part other than the regions 35).

As described above, the area of the detection regions 34, which serve as substantial detection regions when the adjusting plate 20 is in the high-sensitivity position, is larger than the area of the regions 35, which serve as substantial detection regions when the adjusting plate 20 is in the low-sensitivity position. Thus, even if the radiation source emits the same amount of radiation, the amount of radiation incident on the detection regions 34 when the adjusting plate 20 is in the high-sensitivity position is larger than the amount of radiation incident on the regions 35 when the adjusting plate 20 is in the low-sensitivity position. In this manner, the sensitivity of the radiation imaging apparatus 10 can be easily switched by switching the position of the adjusting plate 20 between the high-sensitivity position and the low-sensitivity position. Furthermore, the distance through which the adjusting plate 20 has to move to switch from the high-sensitivity position to the low-sensitivity position can be as short as a single array pitch of the image sensors 33. Therefore, it is only required that the adjusting plate 20 can move within a range in which it covers the detection surface 38, and the size of the radiation imaging apparatus 10 can be reduced when compared to a configuration, such as that disclosed in Japanese Patent Laid-Open No. 2005-152002, in which the entire grid is moved to the outside of the detection apparatus.

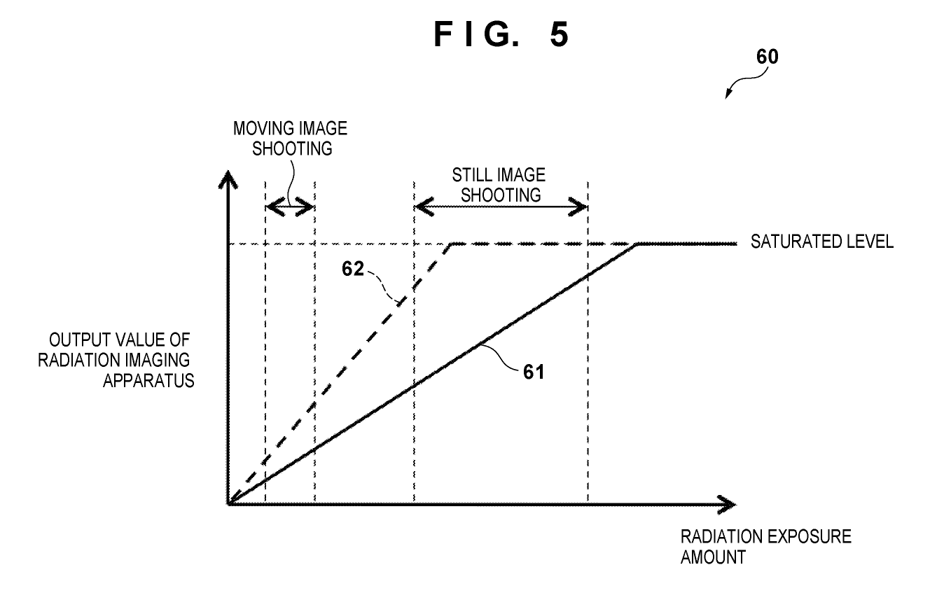

FIG. 5 is a graph 60 illustrating output characteristics of the radiation imaging apparatus against the amount of radiation. The horizontal axis of this graph represents the amount of radiation incident on the radiation imaging apparatus 10, and the vertical axis represents the output value of the radiation imaging apparatus 10. The output value of the radiation imaging apparatus 10 may be proportional to the amount of radiation incident on the detection apparatus 30 until a saturated level is reached. A solid line 61 on the graph 60 indicates the characteristics in the case where the adjusting plate 20 is in the low-sensitivity position, and a dashed line 62 on the graph 60 indicates the characteristics in the case where the adjusting plate 20 is in the high-sensitivity position. As can be seen from the graph 60, even at the same radiation exposure amount, the output value in the case where the adjusting plate 20 is in the high-sensitivity position is higher than the output value in the case where it is in the low-sensitivity position. Generally, the radiation exposure amount used in still image shooting is larger than the radiation exposure amount used in moving image shooting. Accordingly, if still image shooting is performed at a sensitivity suitable for moving image shooting, there are cases where the output value of the radiation imaging apparatus reaches the saturated level as indicated by the dashed line 62 and still image shooting cannot be performed. With the radiation imaging apparatus according to the present embodiment, it is possible to switch the sensitivity of the radiation imaging apparatus 10 by simply switching the position of the adjusting plate 20. Thus, for example, it is only required to set the adjusting plate 20 to the low-sensitivity position in still image shooting and to set the adjusting plate 20 to the high-sensitivity position in moving image shooting. Moreover, even when only moving image shooting is performed, the sensitivity of the radiation imaging apparatus 10 may be switched in accordance with the number of images captured per unit time. For example, if moving image shooting is performed at 7 FPS and 30 FPS, the adjusting plate 20 may be switched so that the higher sensitivity is used when moving image shooting is performed at 30 FPS. In this manner, the sensitivity of the radiation imaging apparatus 10 can be switched depending on various shooting modes including a combination of moving image shooting and still image shooting, a combination of a plurality of numbers of images captured per unit time in moving image shooting, and the like.

As described above, with the radiation imaging apparatus 10, it is possible to easily adjust the sensitivity without changing the characteristics or pattern of the scintillator 31 and the detection substrate 32 by simply switching the position of the adjusting plate 20. Consequently, the radiation imaging apparatus 10 is capable of capturing a favorable image appropriate for each shooting mode.

In the above-described embodiment, the adjusting plate 20 can be fixed in the two positions, namely the high-sensitivity position and the low-sensitivity position, but the radiation imaging apparatus 10 may also be configured so that the adjusting plate 20 can be fixed in three or more positions by setting an appropriate number of rotations of the motor 41. For example, it is possible to adjust the sensitivity of the radiation imaging apparatus 10 in a stepwise manner by configuring the drive unit so that the adjusting plate 20 can be fixed in positions between the high-sensitivity position and the low-sensitivity position in a stepwise manner. For example, the area of substantial detection regions when the adjusting plate 20 is in a third shooting position may be smaller than the area of substantial detection regions when it is in the high-sensitivity position and larger than the area of substantial detection regions when it is in the low-sensitivity position.

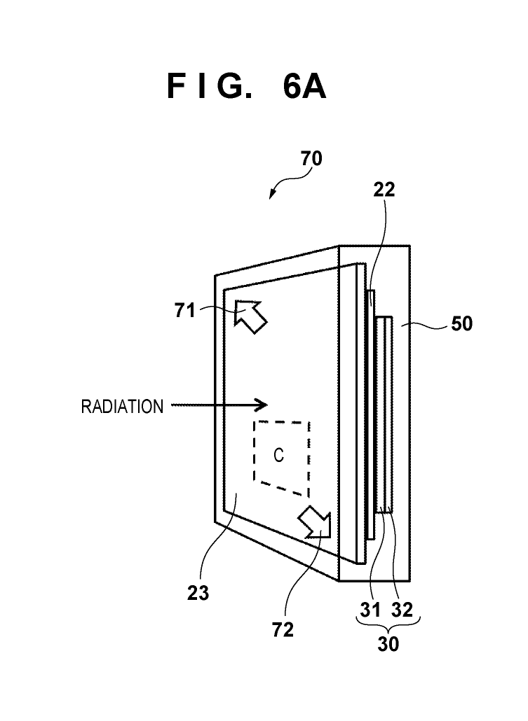

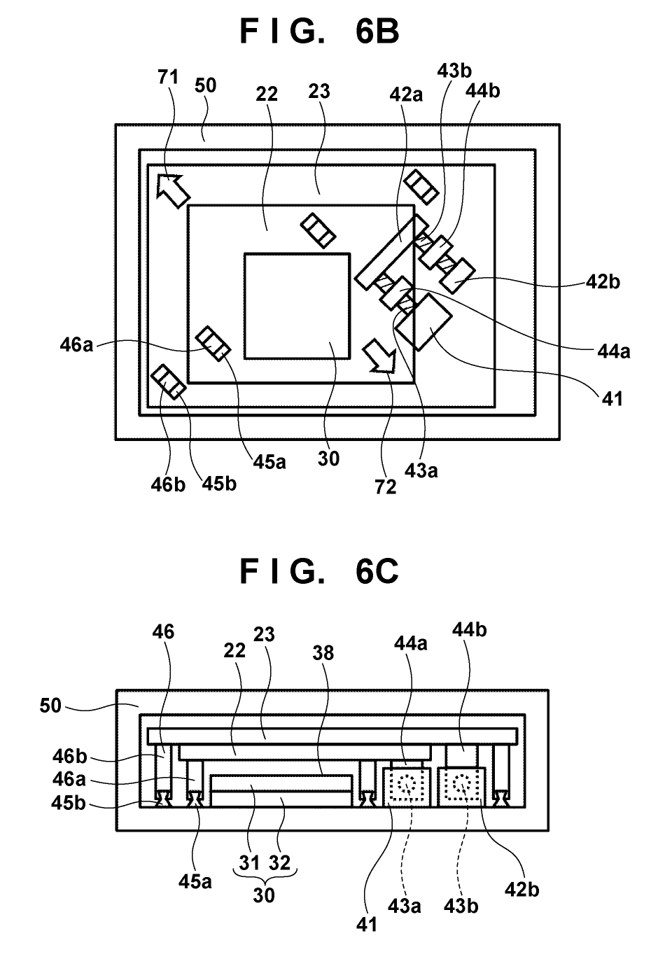

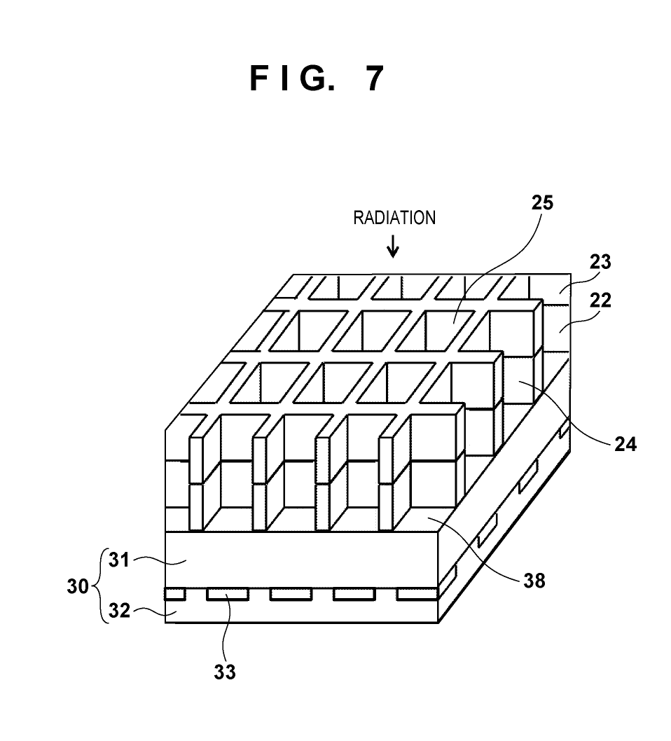

Subsequently, a radiation imaging apparatus 70 according to another embodiment of the present invention will be described using FIGS. 6A to 6C and 7. FIG. 6A is a concise overall view of the radiation imaging apparatus 70, and FIG. 7 is a perspective view focusing on a region C of the radiation imaging apparatus 70. FIG. 6A is a perspective view of the radiation imaging apparatus 70, FIG. 6B is a view of the radiation imaging apparatus 70 as seen from the direction of incidence of radiation, and FIG. 6C is a side view of the radiation imaging apparatus 70. For the sake of clarity, some of components are omitted from FIG. 6A. The radiation imaging apparatus 70 differs from the radiation imaging apparatus 10 in FIG. 1A in that the adjusting plate 20 is replaced by two adjusting plates 22 and 23, but is otherwise the same as the radiation imaging apparatus 10. For this reason, in FIGS. 6A to 6C, the same components as those in FIGS. 1A to 1C are denoted by the same reference numerals, and a redundant description thereof will be omitted.

The adjusting plate 22 (first adjusting plate) and the adjusting plate 23 (second adjusting plate) may both have the same configuration as the adjusting plate 20. That is to say, the adjusting plates 22 and 23 each may be provided with a plurality of apertures 24 or 25 arranged in an array and may be formed of a radiation absorbing member made of a heavy metal material such as lead. In the radiation imaging apparatus 70, the two adjusting plates 22 and 23 laid one on top of the other are disposed on the radiation incident side (left side in FIG. 6A) of the detection apparatus 30, and adjust the amount of radiation incident on the detection regions 34 of the detection apparatus 30. Radiation passing through both of the apertures 24 and 25 of the two adjusting plates 22 and 23 can be incident on the detection apparatus 30. Meanwhile, radiation blocked by either of the two adjusting plates 22 and 23 is not incident on the detection apparatus 30.

The radiation imaging apparatus 70 may further include rails 45a and 45b and supporting members 46a and 46b. The rails 45a and 45b are fixed to the housing 50, the supporting members 46a are fixed to the adjusting plate 22, and the supporting members 46b are fixed to the adjusting plate 23. The supporting members 46a are slidably engaged with the rails 45a at one end, and thus the adjusting plate 22 can move in the direction of, and in the reverse direction of an arrow 72 relative to the detection apparatus 30 while being kept in a position over the detection surface 38. Also, the supporting members 46b are slidably engaged with the rails 45b at one end, and thus the adjusting plate 23 can move in the direction of, and in the reverse direction of an arrow 71 relative to the detection apparatus 30 while being kept in a position over the detection surface 38. That is to say, the rails 45a and 45b and the supporting members 46a and 46b can function as a holding unit that holds the adjusting plates 22 and 23 in such a manner that each adjusting plate can move along the detection surface 38 while being kept in the position over the detection surface 38 of the detection apparatus 30. As will be described in detail later, a position to which each of the adjusting plates 22 and 23 can move includes a high-sensitivity position and a low-sensitivity position with respect to the detection apparatus 30. The sensitivity of the detection apparatus 30 when the adjusting plates 22 and 23 are in the high-sensitivity positions is higher than that when the adjusting plates 22 and 23 are in the low-sensitivity positions.

The radiation imaging apparatus 70 may further include a drive unit including a motor 41, screw boxes 42a and 42b, precision ball screws 43a and 43b, and nuts 44a and 44b. The motor 41 rotates the precision ball screw 43a clockwise and counterclockwise. The screw box 42a rotatably holds an end of the precision ball screw 43a on the opposite side from the motor 41 and also rotatably holds one end of the precision ball screw 43b. The screw box 42a includes a gear (not shown) that operatively connects the precision ball screw 43a and the precision ball screw 43b to each other, and rotates the precision ball screw 43a and the precision ball screw 43b in opposite directions. For example, when the precision ball screw 43a is rotated clockwise as seen from the screw box 42a, the precision ball screw 43b is rotated counterclockwise as seen from the screw box 42a. The screw box 42b rotatably holds the other end of the precision ball screw 43b. The nut 44a is attached to the precision ball screw 43a and also fixed to the adjusting plate 22. The nut 44b is attached to the precision ball screw 43b and also fixed to the adjusting plate 23.

This drive unit enables the movement of the adjusting plates 22 and 23 relative to the detection apparatus 30. For example, if the motor 41 rotates the precision ball screw 43a counterclockwise, the nut 44a approaches the motor 41, and the adjusting plate 22 moves in the direction indicated by the arrow 72 accordingly. At the same time, the nut 44b moves away from the screw box 42b, and the adjusting plate 23 moves in the direction indicated by the arrow 71 accordingly. On the other hand, if the motor 41 rotates the precision ball screw 43a clockwise, the adjusting plates 22 and 23 move in the reverse direction.

The radiation imaging apparatus 70 may further include a control unit (not shown) that controls the operation of the drive unit as is the case with the radiation imaging apparatus 10. Since the operation of the control unit is the same as that described above, a redundant description thereof will not be repeated. In the radiation imaging apparatus 70 as well, the drive unit can fix each of the adjusting plates 22 and 23 in the high-sensitivity position and in the low-sensitivity position.

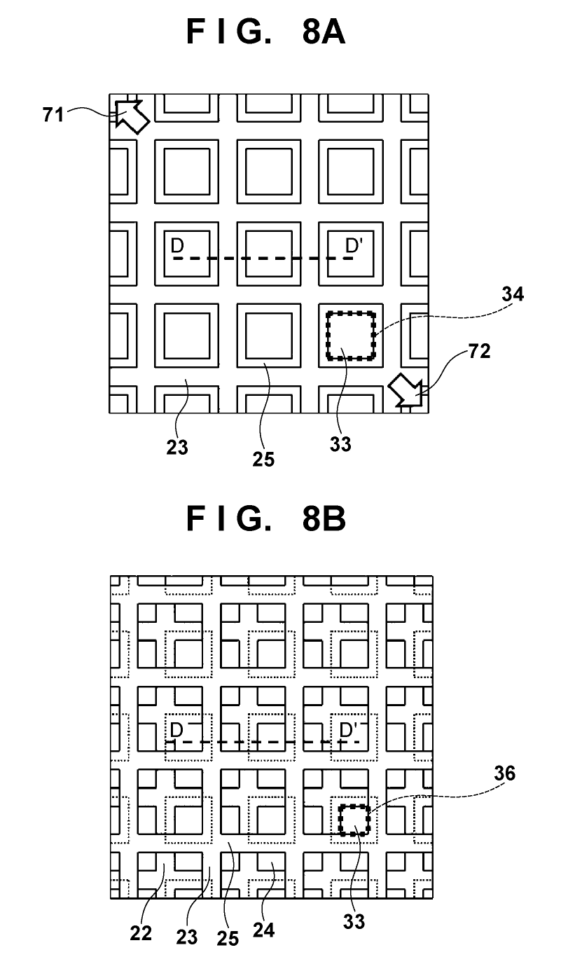

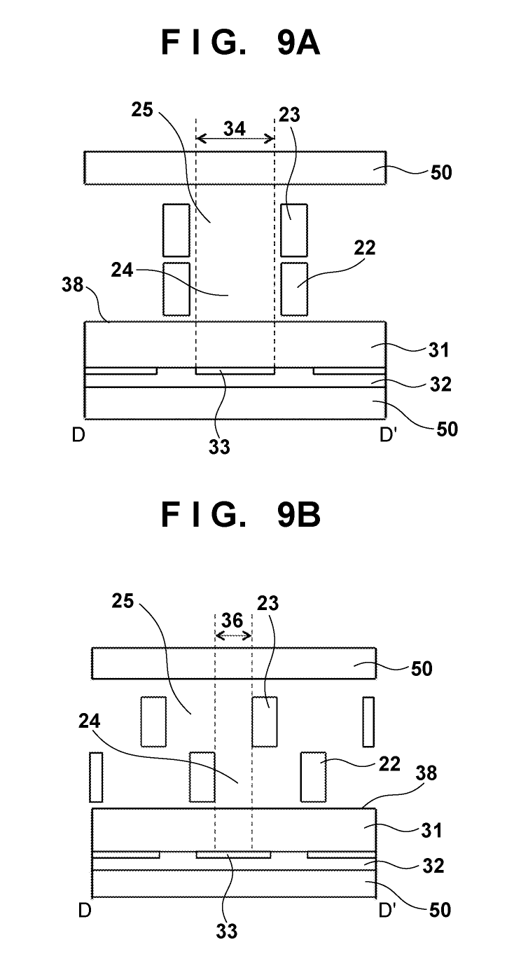

The high-sensitivity positions and the low-sensitivity positions of the two adjusting plates 22 and 23 will be described in detail using FIGS. 8A, 8B, 9A, and 9B. FIGS. 8A and 8B are plan views of the region C in FIG. 6A as seen from the direction of incidence of radiation, and FIGS. 9A and 9B are cross-sectional views taken along line D-D′ in FIGS. 8A and 8B, respectively. For the purpose of illustration, in FIGS. 8A and 8B, the housing 50 is omitted, and the adjusting plates 22 and 23 are shown as transparent. FIGS. 8A and 9A show a state in which the adjusting plates 22 and 23 are in the high-sensitivity positions, and FIGS. 8B and 9B show a state in which the adjusting plates 22 and 23 are in the low-sensitivity positions. The foregoing description with regard to the adjusting plate 20 also applies to the adjusting plates 22 and 23.

As shown in FIGS. 8A and 9A, when the adjusting plates 22 and 23 are in the high-sensitivity positions, the apertures 24 and 25 both overlie the entire detection regions 34. That is to say, the entire detection regions 34 can detect radiation incident on the radiation imaging apparatus 70. On the other hand, as shown in FIGS. 8B and 9B, when the adjusting plates 22 and 23 are in the low-sensitivity positions, the apertures 24 and 25 separately overlie only a part of the detection regions 34. Consequently, regions 36 that are a part of the respective detection regions 34 overlie both the apertures 24 and 25. Radiation incident on the radiation imaging apparatus 70 is incident only on the regions 36 and not on a part of the detection regions 34 covered by the adjusting plates 22 and 23 (the part other than the regions 36).

As described above, the area of the detection regions 34, which serve as substantial detection regions when the adjusting plates 22 and 23 are in the high-sensitivity positions, is larger than the area of the regions 36, which serve as substantial detection regions when the adjusting plates 22 and 23 are in the low-sensitivity positions. Thus, with the radiation imaging apparatus 70 as well, it is possible to easily switch the sensitivity of the radiation imaging apparatus 70 by switching the positions of the adjusting plates 22 and 23 between the high-sensitivity positions and the low-sensitivity positions. Moreover, the distance through which each of the adjusting plates 22 and 23 has to move to switch from the high-sensitivity position to the low-sensitivity position can be as short as a single array pitch of the image sensors 33, and therefore the size of the radiation imaging apparatus 70 can be reduced.

In the radiation imaging apparatus 70, in order to switch from the high-sensitivity positions to the low-sensitivity positions, the adjusting plate 23 is moved in the direction of the arrow 71 (first direction), and the adjusting plate 22 is moved in the direction of the arrow 72 (second direction). Displacements of the centroids of the regions 36 from the centroids of the respective detection regions 34 can be decreased by moving the two adjusting plates 22 and 23 in opposite directions in this manner. Here, “opposite directions” means that the angle formed by respective moving directions of the two adjustment plates is larger than 90 degrees. In particular, the centroids of the regions 36 can be made to coincide with the centroids of the respective detection regions 34 by moving the two adjusting plates 22 and 23 in reverse directions, that is, in respective moving directions that form an angle of 180 degrees. Moreover, the shape of the apertures 24 and 25 and the moving directions of the adjusting plates 22 and 23 may be designed so that the detection regions 34 and the regions 36 have the same shape, that is, the detection regions 34 and the regions 36 are geometrically similar. Although a case where the radiation imaging apparatus 70 has two adjusting plates was described, even if the number of adjusting plates provided in the radiation imaging apparatus 70 is any particular number greater than two, it is possible to adjust the sensitivity of the radiation imaging apparatus by changing the positions of those adjusting plates as well. Moreover, as is the case with the radiation imaging apparatus 10, in the radiation imaging apparatus 70, it is possible to adjust the sensitivity of the radiation imaging apparatus 70 in a stepwise manner by configuring the drive unit so that each of the adjusting plates 22 and 23 can be fixed in positions between the high-sensitivity position and the low-sensitivity position in a stepwise manner.

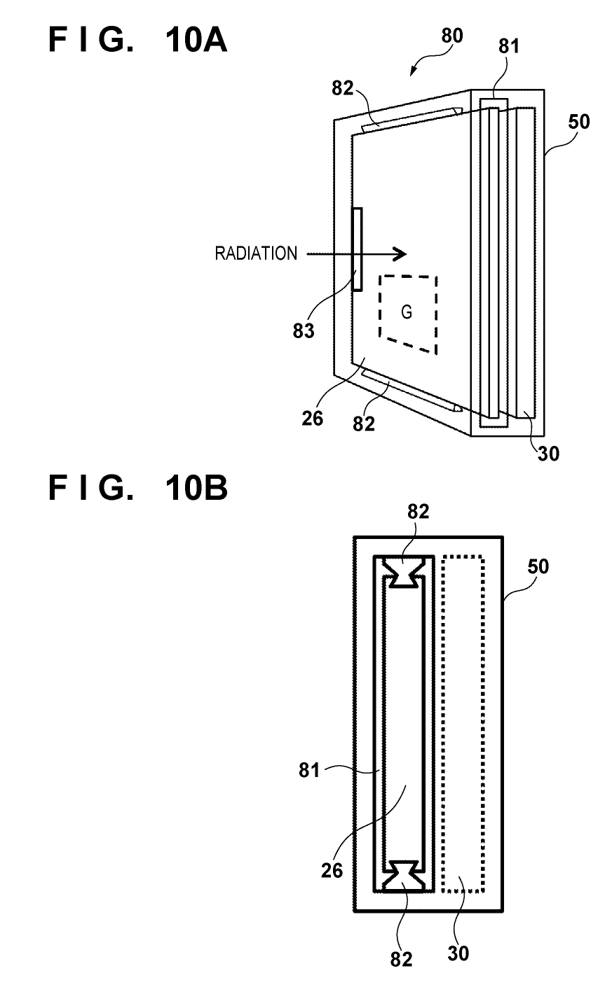

Subsequently, a radiation imaging apparatus 80 according to another embodiment of the present invention will be described using FIGS. 10A and 10B. The radiation imaging apparatus 80 differs from the radiation imaging apparatus 10 in FIG. 1A in that the adjusting plate 20 is replaced by a removable adjusting plate 26, but is otherwise the same as the radiation imaging apparatus 10. For this reason, in FIGS. 10A and 10B, the same components as those in FIGS. 1A to 1C are denoted by the same reference numerals, and a redundant description thereof will be omitted.

The adjusting plate 26, which may have the same structure as the adjusting plate 20, can be mechanically attached to and removed from the radiation imaging apparatus 80 through a slot 81 provided in the housing 50. When the adjusting plate 26 is attached to the radiation imaging apparatus 80, the adjusting plate 26 is disposed on the radiation incident side (left side in FIG. 10A) of the detection apparatus 30 and adjusts the amount of radiation incident on the detection regions 34 of the detection apparatus 30. Radiation passing through apertures of the adjusting plate 26 can be incident on the detection apparatus 30. Meanwhile, radiation blocked by the adjusting plate 26 is not incident on the detection apparatus 30.

The housing 50 of the radiation imaging apparatus 80 has rails 82 inside the slot 81, and grooves engageable with the rails 82 are formed in side surfaces of the adjusting plate 26. This enables the user of the radiation imaging apparatus 80 to attach the adjusting plate 26 to the radiation imaging apparatus 80. The radiation imaging apparatus 80 may further include a stopper 83, and the adjusting plate 26 inserted in the slot 81 is stopped by the stopper 83. The position of the adjusting plate 26 at which it is stopped by the stopper 83 is a shooting position, which will be described later. That is to say, the rails 82 and the stopper 83 may function as a holding unit for removably holding the adjusting plate 26 and guiding the adjusting plate 26 to the shooting position. Moreover, the stopper 83 may have a lock mechanism for fixing the adjusting plate 26 in the shooting position. If the stopper 83 has the lock mechanism, displacement of the adjusting plate 26 during shooting can be prevented. Moreover, the adjusting plate 26 can be fixed without using the lock mechanism depending on the orientation of the slot 81 during a period in which shooting is performed using the radiation imaging apparatus 80. For example, when the slot 81 faces the upper side or the lateral side of the radiation imaging apparatus 80, the adjusting plate 26 may be fixed in the shooting position by frictional forces and normal forces between the adjusting plate 26 and the rails 82 and the stopper 83. In this case, the rails 82 and the stopper 83 may function as a fixing unit.

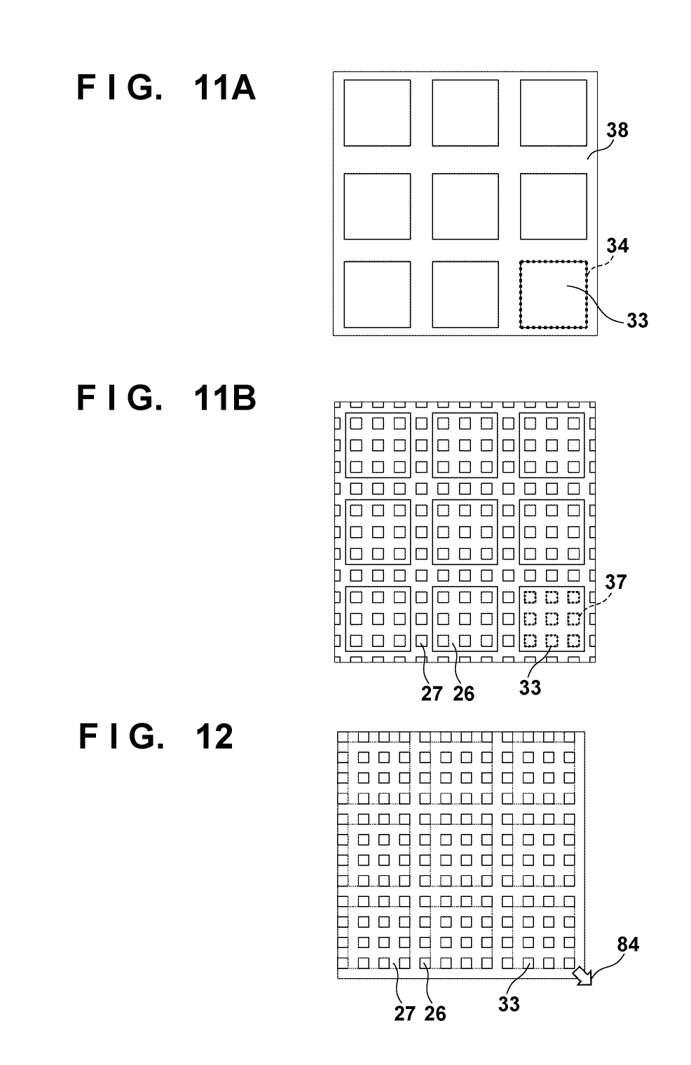

A case where the adjusting plate 26 is attached and a case where it is removed will be described in detail using FIGS. 11A and 11B. FIGS. 11A and 11B are plan views of a region G in FIG. 10A as seen from the direction of incidence of radiation. For the purpose of illustration, the housing 50 is omitted from FIGS. 11A and 11B. FIG. 11A shows a state in which the adjusting plate 26 is removed, and FIG. 11B shows a state in which the adjusting plate 26 is attached and fixed. The foregoing description with regard to the adjusting plate 20 also applies to the adjusting plate 26.

As shown in FIG. 11A, when the adjusting plate 26 is removed, the entire detection regions 34 can detect radiation incident on the radiation imaging apparatus 10. On the other hand, as shown in FIG. 11B, when the adjusting plate 26 is attached, the apertures 27 overlie only regions 37 (each of which is a set of nine regions enclosed by dotted lines) that are a part of the respective detection regions 34. That is to say, radiation incident on the radiation imaging apparatus 80 is incident only on the regions 37 and not on a part of the detection regions 34 covered by the adjusting plate 26 (the part other than the regions 37).

As described above, the area of the detection regions 34, which serve as substantial detection regions in a state in which the adjusting plate 26 is removed, is larger than the area of the regions 37, which serve as substantial detection regions in a state in which the adjusting plate 26 is attached. That is to say, the sensitivity in the state in which the adjusting plate 26 is removed is higher than that in the state in which the adjusting plate 26 is attached. Thus, with the radiation imaging apparatus 80 as well, it is possible to easily switch the sensitivity of the radiation imaging apparatus 80 by attaching or removing the adjusting plate 26. Since a drive unit that moves the adjusting plate 26 is unnecessary for the configuration of the radiation imaging apparatus 80, a further size reduction can be achieved when compared to the above-described radiation imaging apparatuses 10 and 70.

There is no limitation to the number of apertures 27 that overlie a single detection region 34 when the adjusting plate 26 is attached to the radiation imaging apparatus 80. In the example shown in FIGS. 11A and 11B, a plurality of equidistantly arranged apertures 27 overlie a single detection region 34. Moreover, the array pitch of the detection regions 34 is four times the array pitch of the apertures 27. With such a configuration, even if the adjusting plate 26 is fixed in a position displaced in the direction of an arrow 84 relative to the detection apparatus 30 as shown in FIG. 12, the area of the regions 37 serving as substantial detection regions can be maintained. This eliminates the need for alignment of the adjusting plate 26 with the detection apparatus 30 and enables mechanical attachment/removal with a large allowable margin of error in positioning. Generally, any array pitch of the detection regions 34 that is “n” (“n” is an integer of 2 or greater) times the array pitch of the apertures 27 enables the area of the regions 37 to be maintained even if the adjusting plate 26 is fixed in a displaced position.

It is also possible to combine the above-described embodiments. For example, in the case of a radiation imaging apparatus having a plurality of adjusting plates, a configuration may be adopted in which a part of the adjusting plates is removable and another part of the adjusting plates can take two positions within the radiation imaging apparatus. Moreover, the radiation shielding member may have transmitting regions having a higher radiation transmittance than a surrounding region instead of the apertures. That is to say, the adjusting plate may have transmitting regions arranged in an array and a shielding region (region other than the transmitting regions) having a lower radiation transmittance than the transmitting regions. The adjusting plate is fixed in such a manner that the area of a part of the detection regions 34 overlain by the transmitting regions when the adjusting plate is in the high-sensitivity position is larger than the area of a part of the detection regions 34 overlain by the transmitting regions when the adjusting plate is in the low-sensitivity position. Thus, the amount of radiation incident on the detection regions 34 when the adjusting plate is in the high-sensitivity position is larger than the amount of radiation incident on the detection regions 34 when the adjusting plate is in the low-sensitivity position, and the sensitivity of the radiation imaging apparatus can be adjusted. With regard to the above-described embodiments, the shielding region corresponds to the adjusting plate, and the transmitting regions correspond to the apertures. Moreover, the transmitting regions may be formed from a substance having a higher radiation transmittance than the shielding region, or the adjusting plate may be formed so that the transmitting regions have a smaller thickness than the shielding region. Furthermore, the distribution of radiation transmittance values within each transmitting region may not be uniform. For example, the radiation transmittance values may have a distribution in which the radiation transmittance is at its maximum near the center of the transmitting region and gradually decreases as the distance to the shielding region decreases. Also, only a part of the plurality of detection regions may be the detection regions in which the area of substantial detection regions varies depending on the position of the adjusting plate. For example, the aperture size of the adjusting plate may be set so that the sensitivity of detection regions located on the inner side of the detection apparatus 30 can be switched, while the sensitivity of detection regions located along the periphery of the detection apparatus 30 is always high.

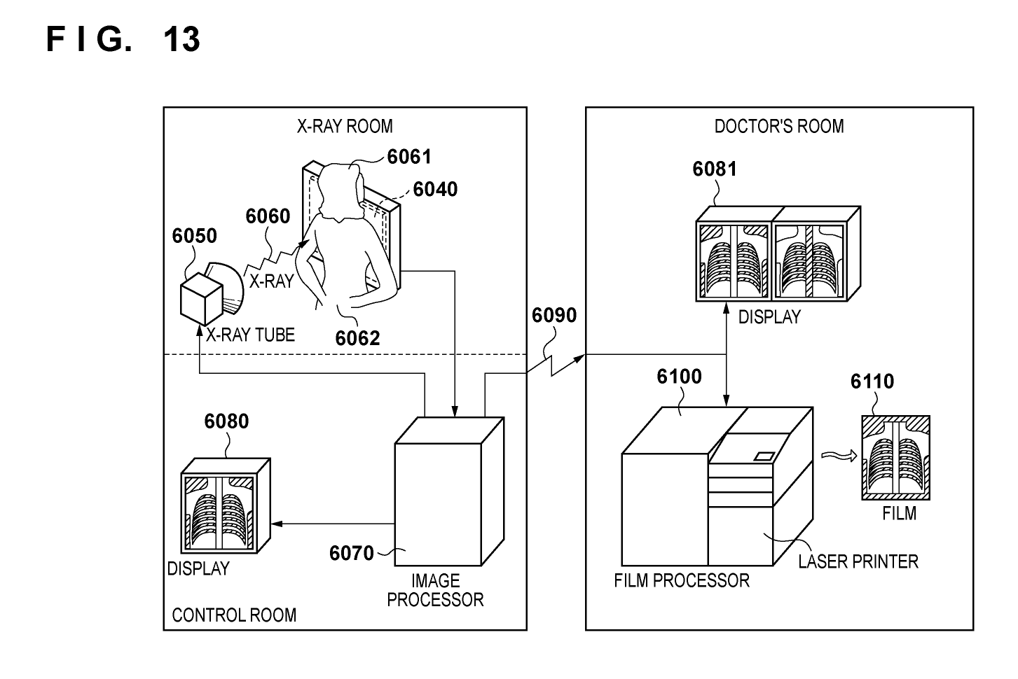

FIG. 13 is a diagram illustrating an application of the radiation imaging apparatuses of the above-described embodiments to an X-ray diagnostic system (radiation imaging system). X-rays 6060 serving as radiation generated in an X-ray tube 6050 (radiation source) are transmitted through the chest 6062 of a subject or patient 6061 and incident on a radiation imaging apparatus 6040, which may be any of the radiation imaging apparatuses of the above-described embodiments. The incident X-rays contain information on the interior of the body of the patient 6061. In response to the incidence of the X-rays, the scintillator 31 emits light, which is then electrically converted to obtain electrical information. The obtained information is converted into digital signals, which are in turn subjected to image processing by an image processor 6070 serving as a signal processing unit and then can be observed on a display 6080 serving as a display unit in a control room. Note that the radiation imaging system has at least a radiation imaging apparatus and a signal processing unit that processes a signal from the radiation imaging apparatus.

Moreover, the information can be transferred to a remote place via a transmission processing unit such as a telephone line 6090 and can be displayed on a display 6081 or saved on a recording medium such as an optical disc in a doctor's room and the like at the separate location, and it is also possible for a doctor in the remote place to make a diagnosis. Moreover, the information can be recorded on a film 6110 serving as a recording medium by a film processor 6100 serving as a recording unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-158453, filed Jul. 19, 2011, which is hereby incorporated by reference herein in its entirety.

What is claimed is:

1. A radiation imaging apparatus comprising:
a detection apparatus that has a detection surface on which a plurality of detection regions detecting radiation are arranged in an array and generates a signal corresponding to the amount of radiation incident on each of the detection regions;
at least one adjusting plate in which a plurality of transmitting regions transmitting radiation are arranged in an array and which adjusts the amount of radiation incident on the plurality of detection regions by blocking radiation incident on a region other than the plurality of transmitting regions;
a holding unit that holds the at least one adjusting plate in such a manner that the at least one adjusting plate can move along the detection surface while being kept in a position over the detection surface of the detection apparatus; and
a drive unit that moves the at least one adjusting plate,
wherein the drive unit can fix the at least one adjusting plate in a plurality of positions relative to the detection surface, and
in at least one of the plurality of detection regions, the area of a part of the detection region on which radiation transmitted through the at least one adjusting plate is incident varies depending on the position of the at least one adjusting plate relative to the detection surface.

2. The radiation imaging apparatus according to claim 1,
wherein the at least one adjusting plate includes a first adjusting plate and a second adjusting plate laid one on top of the other, and
when the drive unit moves the first adjusting plate in a first direction, the drive unit moves the second adjusting plate in a second direction different from the first direction.

3. The radiation imaging apparatus according to claim 2, wherein the second direction is a direction opposite to the first direction.

4. The radiation imaging apparatus according to claim 1, wherein the transmitting regions of each of the at least one adjusting plate are apertures provided in the adjusting plate.

5. A radiation imaging apparatus comprising:
a detection apparatus that has a detection surface on which a plurality of detection regions detecting radiation are arranged in an array and generates a signal corresponding to the amount of radiation incident on each of the detection regions;
an adjusting plate in which a plurality of transmitting regions transmitting radiation are arranged in an array and which adjusts the amount of radiation incident on the plurality of detection regions by blocking radiation incident on a region other than the plurality of transmitting regions;
a holding unit that removably holds the adjusting plate and guides the adjusting plate to a position over the detection surface of the detection apparatus; and
a fixing unit that fixes the adjusting plate guided to the position,
wherein in at least one of the plurality of detection regions, the area of a part of the detection region on which radiation is incident when the adjusting plate is removed is larger than the area of a part of the detection region on which radiation transmitted through the adjusting plate is incident when the adjusting plate is fixed in the position.

6. The radiation imaging apparatus according to claim 5,
wherein an array pitch of the plurality of detection regions is “n” (“n” is an integer of 2 or greater) times an array pitch of the plurality of transmitting regions.

7. The radiation imaging apparatus according to claim 5, wherein the transmitting regions of the adjusting plate are apertures provided in the adjusting plate.

8. A radiation imaging system comprising:
the radiation imaging apparatus according to claim 1; and
a signal processing unit that processes a signal obtained by the radiation imaging apparatus.

9. A radiation imaging system comprising:
the radiation imaging apparatus according to claim 5; and
a signal processing unit that processes a signal obtained by the radiation imaging apparatus.
